(19) United States
(12) Patent Application Publication
(10) Pub. No.: US 2026/0298777 A1
(43) Pub. Date: Oct. 1, 2026

(54) RAPID SCREENING OF VOLATILE CHEMICALS WITH PROTON TRANSFER REACTION MASS SPECTROMETRY

(71) Applicant: Purdue Research Foundation, West Lafayette, IN (US)

(72) Inventors: Nusrat Jung, West Lafayette, IN (US); Andrew J. Whelton, West Lafayette, IN (US); Brandon Emil Boor, West Lafayette, IN (US)

(73) Assignee: Purdue Research Foundation, West Lafayette, IN (US)

(21) Appl. No.: 19/576,356

(22) Filed: Mar. 24, 2026

Related U.S. Application Data
(60) Provisional application No. 63/777,108, filed on Mar. 25, 2025.

(51) Int. Cl. G01N 1/22; G01N 27/623; G01N 27/64

(52) U.S. Cl. CPC G01N 1/2226; G01N 27/623; G01N 27/64; G01N 2001/2229

(57) ABSTRACT

A system is provided for analyzing volatile compounds from a liquid sample using proton transfer reaction time-of-flight mass spectrometry (PTR-TOF-MS). The system includes a PTR-TOF-MS device, a pressurized zero-air supply, and a sample container defining a headspace above a liquid sample. A purge valve selectively introduces zero air into the headspace, and a sample valve selectively delivers headspace gas to the mass spectrometer. In a purge mode, zero air flows through the headspace and into the PTR-TOF-MS device. In an equilibrium mode, both valves restrict flow to fluidly isolate the headspace, allowing volatile compounds to reach static gas-liquid equilibrium. In a sampling mode, headspace gas is delivered to the PTR-TOF-MS device for a defined sampling duration.

### CROSS REFERENCE TO RELATED APPLICATIONS

This application claims the benefit of U.S. Provisional Patent Application No. 63/777,108, filed on Mar. 25, 2025, the entirety of which is incorporated herein by reference.

### GOVERNMENT FUNDING

This invention was made with government support under CBET-1847493 and CBET-2327139 awarded by the National Science Foundation. The government has certain rights in the invention.

### TECHNICAL FIELD

This disclosure relates to screening of volatile chemicals and, in particular, to sampling using mass spectrometry.

### BACKGROUND

In the United States, hazardous chemical incidents, including fires, explosions, and chemical releases, are a common occurrence. There were approximately 172,000 chemical spills that affected waterbodies between 2004 and 2014. Approximately 2% to 16% of unconventional oil and gas wells in four states of the U.S. report a spill each year, resulting in chemical release to air and water, and subsequently infiltration of emulsions into soil. Over the past 20 years, hundreds of thousands of chemical incidents have impacted drinking water sources. In response to hazardous chemical incidents, the Emergency Response Guidebook (ERG) provides guidelines that can help first responders in these events, with procedures on recommended evacuation distances, personal protective equipment, first aid, and isolation practices. Depending on the complexity of an incident, experts from outside the area may be consulted, but response is always initiated by local emergency services. Should a disaster exceed local capabilities, assistance from state and federal agencies may be requested.

Rapid evaluation of air, water, and soil contamination and human exposure risks is critical to decision making. This helps officials minimize population exposures and environmental harm. An effective and reliable approach to assess air, water, and soil contamination, and subsequent human exposures, is urgently needed. Hazardous chemical incidents and spills, such as the 2023 East Palestine, Ohio train derailment, are a frequent occurrence in the U.S. that put communities at risk of exposure to complex mixtures of volatile and semi-volatile chemicals. On Feb. 3, 2023, a Norfolk Southern train derailed in East Palestine, Ohio (40.8360°N, 80.5227°W) due to an overheated wheel bearing. Eleven derailed train cars carried hazardous chemicals, including vinyl chloride (C2H3Cl), isobutylene (C4H8), butyl acrylate (C7H12O2), 2-ethylhexyl acrylate (C11H20O2), 2-butoxyethanol (C6H14O2), and benzene (C6H6). Notably, over 100,000 gal of vinyl chloride, a human carcinogen, were released into the environment following the train derailment. This derailment was followed by a deliberate chemical burn, resulting in the transformation of chemical constituents due to combustion and pyrolysis. Residents of East Palestine reported visual and olfactory signs of exposure to contamination as well as symptoms such as headaches, anxiety, coughing, fatigue, tiredness, irritation, and pain or burning of skin. Health concerns due to the volatile nature of spilled chemicals underscore an urgent need for enhanced contaminant detection methods to assess environmental and health hazards effectively and reliably and to ensure the well-being of affected residents.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a headspace sampling system

FIG. 2 illustrates an example of a headspace sampling system during a purge mode.

FIG. 3 illustrates an example of a headspace sampling system during an equilibrium mode.

FIG. 4 illustrates an example of a headspace sampling system during a sampling mode.

### DETAILED DESCRIPTION

Historically, several techniques have been used to monitor air and water composition after chemical incidents. Photoionization detectors (PIDs) are sometimes used for volatile organic compound (VOC) sampling due to their low cost, portability, and relatively expansive range. In Ohio, air sampling was conducted using PIDs by the U.S. Environmental Protection Agency (EPA). However, PIDs do not provide reliable data on chemical loadings in an environment as they fail to speciate chemical compounds, can underestimate volatile chemical concentrations by one to two orders of magnitude, and are prone to signal interferences due to ambient moisture. In addition, PIDs respond to different VOCs with different sensitivities, and PID performance has only been evaluated for a limited number of VOCs. PID readings can be challenging to interpret, especially following chemical spill events where a complex mixture of compounds can be released. A second approach to air sampling is to utilize sorbent tube and canister sampling, followed by offline analysis via thermal desorption-gas chromatography-mass spectrometry (TD-GC-MS) or GC-flame ionization detection (GC-FID). Such techniques generally offer poor time-resolution, can result in long delays in sample processing and analysis, and cannot be scaled to achieve multi-media environmental sampling in the field.

GC-MS and GC-FID are commonly used to analyze VOCs in water samples, including drinking water, wastewater, and surface water. Following the 2023 East Palestine, Ohio train derailment, air, water, and soil samples were collected by responding organizations and the VOC composition of the samples was analyzed by laboratories using U.S. EPA Method TO-15 for the air samples and Method 8260D for the water and soil samples. Both methods use a GC-MS to examine the VOC loadings in the samples. Such techniques often require sample preparation and a relatively long sample analysis time ranging from 20 min to >1 h for each sample. While GC-MS and GC-FID can precisely characterize the chemical composition of water samples, such techniques, coupled with sample preparation, may slow down chemical disaster emergency response and decision making by public health officials.

To identify environmental and public health risks more rapidly at a chemical disaster site, improved sampling and analysis approaches are needed. Here, novel online mass spectrometry was applied for rapid characterization of the chemical contamination of surface water samples collected near the East Palestine train derailment site. Specifically, proton transfer reaction time-of-flight mass spectrometry (PTR-TOF-MS) with hydronium (H₃O⁺) as the reagent ion was used. PTR-TOF-MS is a form of chemical ionization mass spectrometry (CIMS) that has been used for online monitoring of VOC concentrations in atmospheric environments. The PTR-TOF-MS can be expanded to other forms of CIMS when configured with different reagent ions, such as NH₄ ⁺, O₂ ⁺, and NO⁺, to improve detection of different categories of VOCs. PTR-TOF-MS enables detection of VOCs at concentrations as low as a few ppt with high sensitivity, fast response (<100 ms), and high mass resolution (>6000 m/Δm).

To characterize the VOC composition of liquid and solid samples, PTR-TOF-MS has the advantage that sample pretreatment is not necessary compared to conventional analytical methods including GC-MS or GC-FID. VOCs that vaporize into the headspace of the sample can be directly analyzed by the PTR-TOF-MS. Real-time headspace sampling with PTR-TOF-MS has been previously applied in food and flavor analysis, including for wine, fruits, and coffee, to determine their aroma or origin. PTR-TOF-MS has also been used for solid material analysis by sampling VOCs in the headspace of soil samples and polymer 3D printing materials. Real-time headspace VOC monitoring via PTR-TOF-MS has been applied to understand the multiphase partitioning of specific compounds applied a PTR-TOF-MS to monitor water disinfectant degradation kinetics and demonstrated a sensitivity consistent with other analytical methods.

As an online monitoring technique with high time-resolution, PTR-TOF-MS can also be implemented for mobile air or water sampling. PTR-TOF-MS can be installed on a mobile vehicle or a ship to map the spatiotemporal distribution of VOCs in the air or in surface water. PTR-TOF-MS has the potential to be applied for rapid screening of volatile chemicals in surface water samples with a headspace sampling system. Such an online technique can be particularly valuable in emergency response to chemical disasters such as the East Palestine train derailment where rapid decisions are critical and can greatly enhance the capability to manage environmental and public safety more effectively.

The system and methods described herein provide technical advancements for rapid screening of VOCs in surface water samples. By way of example, this disclosure provides advancements for preparing and performing static headspace sampling system with a PTR-TOF-MS to characterize VOCs in the surface water samples.

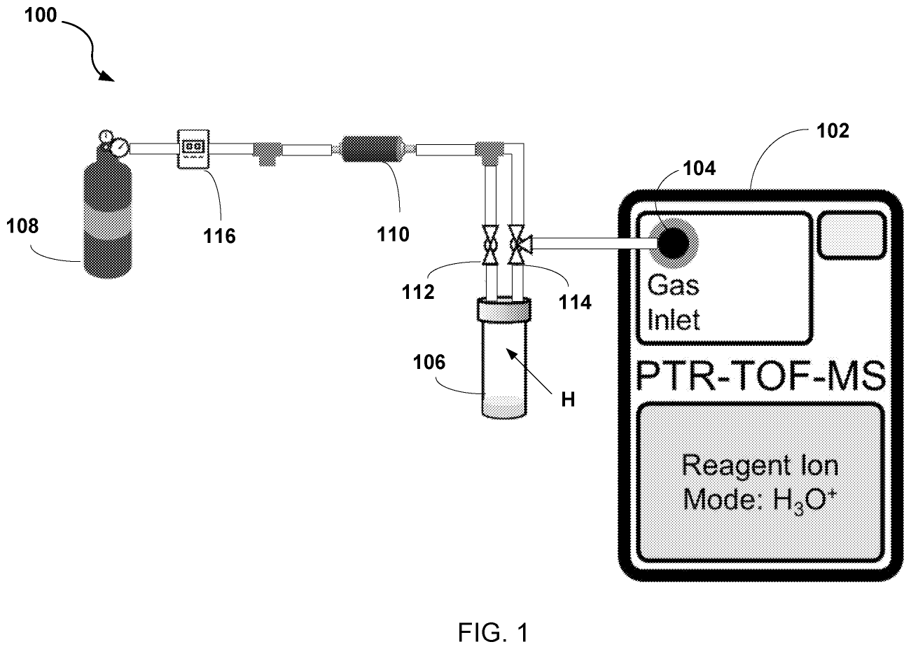

FIG. 1 illustrates an example of a headspace sampling system 100. The system 100 includes a proton transfer reaction time-of-flight mass spectrometry (PTR-TOF-MS) device 102 comprising a gas inlet 104 configured to receive gaseous samples for real-time mass spectrometric analysis. The PTR-TOF-MS device 102 may be operated such that suction at the gas inlet 104 draws gas samples into the device during analysis.

The system 100 further includes a sample container 106 having a liquid sample disposed therein and defining a headspace (labled H in FIG. 1) above the liquid sample. The headspace is configured to receive volatile compounds released from the liquid sample and to provide the volatile compounds to the PTR-TOF-MS device 102 for analysis.

An air supply 108 is provided and configured to deliver zero air under pressure to the system 100. In some examples, the zero air comprises ultra-zero air selected to minimize contamination from background volatile organic compounds. However, the zero air may still contain trace hydrocarbon impurities. Accordingly, in some embodiments, the system further includes a hydrocarbon filter 110 fluidly connected downstream of the air supply 108 and upstream of the headspace to further remove hydrocarbon impurities from the zero air prior to introduction into the headspace or delivery to the PTR-TOF-MS device.

The system may include a purge valve 112 fluidly connected downstream of the air supply 108 and upstream of the headspace of the sample container 106. For example, the purge valve may receive filtered zero air from the hydrocarbon filter. The purge valve 112 is configured to selectively permit or restrict the flow of zero air into the headspace of the sample container 106, and govern the flow of zero air into the headspace H. In some examples, the purge valve may be a two-way valve which may be electrically or mechanically actuated.

The system may include a sample valve 114 fluidly connected downstream of the headspace of the sample container and upstream of the gas inlet 104 of the PTR-TOF-MS device 102. The sample valve is configured to selectively permit or restrict the flow of air from the headspace of the sample container to the gas inlet of the PTR-TOF-MS device. In some examples, the sample valve is implemented as a three-way valve. In such examples, the sample valve may be configured to selectively permit air from the headspace to flow to the gas inlet 104, to restrict air from flowing from the headspace, or to permit zero air from the air supply 108 to bypass the headspace and flow directly to the gas inlet 104 of the PTR-TOF-MS device 102. Accordingly, the sample valve may have a closed state, a head space to gas inlet state, and a bypass state where zero air is supplied directly to the gas inlet bypassing the headspace. In other examples, a two-way valve may be used for the sample valve, and a third valve may control the flow of zero air which bypasses the head space and is applied directly to the gas inlet.

In some embodiments, the system further includes a mass flow controller 116 disposed downstream of the air supply and upstream of the purge valve 112, sample valve 114, and/or hydrocarbon filter 110. The mass flow controller 116 is configured to regulate a flow rate of zero air delivered to the system 100 and to provide a flow rate that exceeds an inlet flow rate of the PTR-TOF-MS device, thereby enabling stable operation and preventing over-pressurization of the sample container.

The system may include various other three-way connectors and/or pressure release valves. For example, a pressure release valve may be positioned between the upstream of the filter 110 and set to release pressure at a threshold in order to avoid over pressurization. Three-way connector may be positioned upstream of the purge valve 112 and sample valve. The three-way connector may receive gas flow from the source 108 and directed it to the purge valve and sample value, depending on the state of the valves 112, 114.

The configuration illustrated in FIG. 1 enables the headspace of the sample container to be selectively purged, isolated to establish a static gas-liquid equilibrium, and sampled. In some examples, the static headspace equilibrium facilitates estimation of an aqueous concentration of volatile organic compounds based on measured headspace concentrations and a Henry's Law relationship.

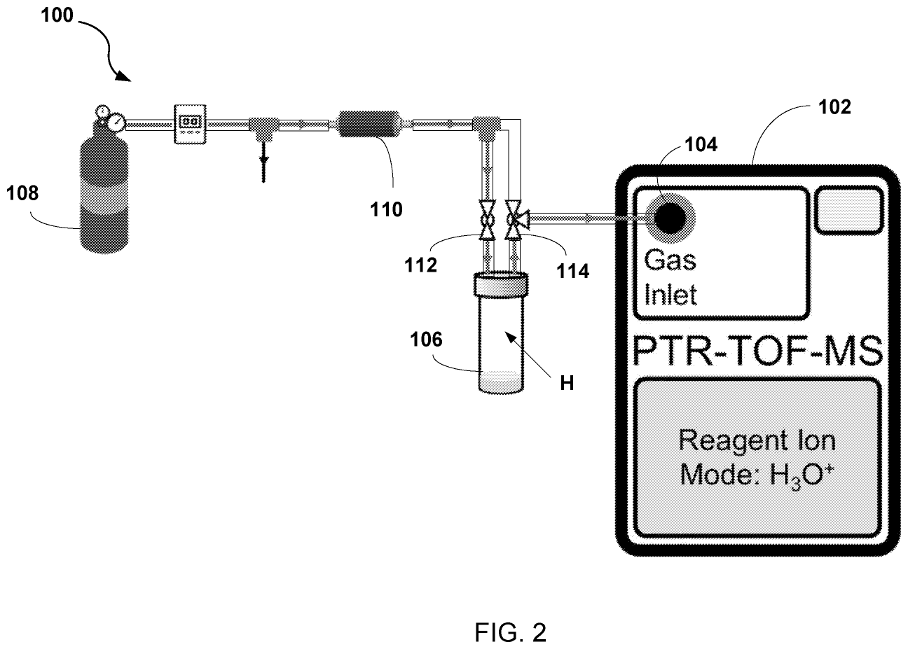

Although illustrated schematically, the components of FIG. 1 cooperate to permit operation of the system in multiple modes, including a purge mode, an equilibrium mode, and a sampling mode, which are described in further detail with respect to FIGS. 2-4.

FIG. 2 illustrates an example of the headspace sampling system 100 during a purge mode. During the purge mode, the purge valve 112 is controlled to permit zero air supplied by the air supply 108 to flow into the headspace of the sample container 106.

While the purge valve 112 permits zero air to enter the headspace, the sample valve 114 is controlled to permit air from the headspace of the sample container 106 to flow to the gas inlet 104 of the PTR-TOF-MS device 102. In this configuration, zero air entering the headspace displaces air previously present in the headspace, and the displaced air is conveyed from the headspace to the PTR-TOF-MS device 102. The purge mode may thereby flush the headspace, associated flow paths, and the gas inlet 104 of the PTR-TOF-MS device 102 to reduce contamination from ambient air or residual volatile compounds.

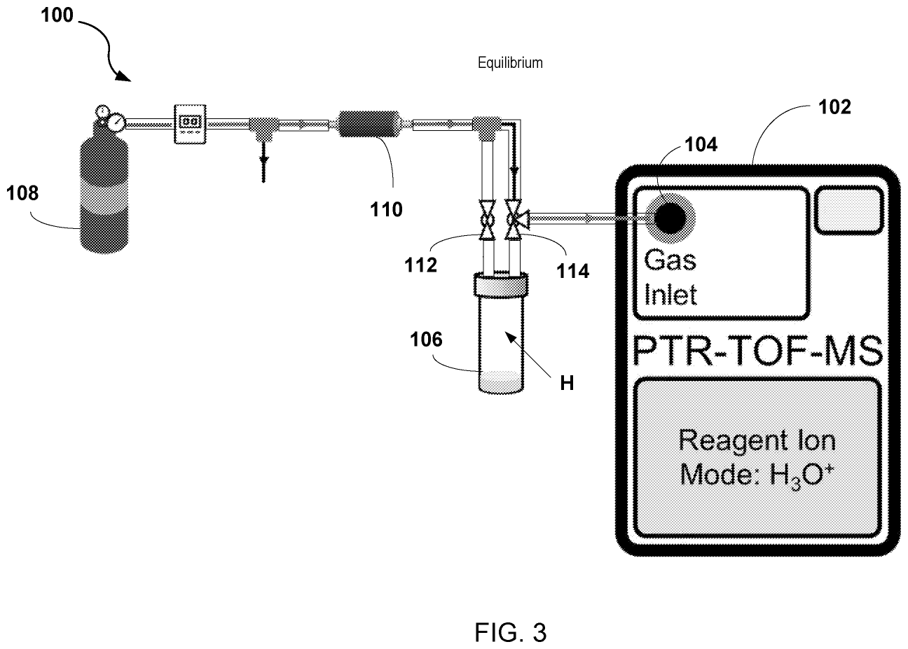

In some examples, the purge mode is performed prior to establishing a static gas-liquid equilibrium in the headspace. The purge mode may be terminated by controlling the purge valve 112 to restrict zero air from entering the headspace, as described in further detail with respect to FIG. 3.

FIG. 3 illustrates an example of the headspace sampling system 100 during an equilibrium mode. The equilibrium mode is initiated after completion of the purge mode described with respect to FIG. 2.

During the equilibrium mode, the purge valve 112 is controlled to restrict zero air from entering the headspace of the sample container 106. In addition, the sample valve 114 is controlled to restrict air from flowing from the headspace of the sample container 106 to the gas inlet 104 of the PTR-TOF-MS device 102. In this configuration, the headspace of the sample container 106 is fluidly isolated, allowing volatile compounds in the liquid sample to partition between the liquid phase and the gas phase and to establish a static gas-liquid equilibrium.

In some examples, while the headspace remains fluidly isolated during the equilibrium mode, the sample valve 114 is configured to permit zero air supplied by the air supply 108 to bypass the headspace and flow directly to the gas inlet 104 of the PTR-TOF-MS device 102. In such examples, zero air is supplied to the PTR-TOF-MS device 102 during the equilibrium mode without disturbing the static gas-liquid equilibrium established in the headspace of the sample container 106.

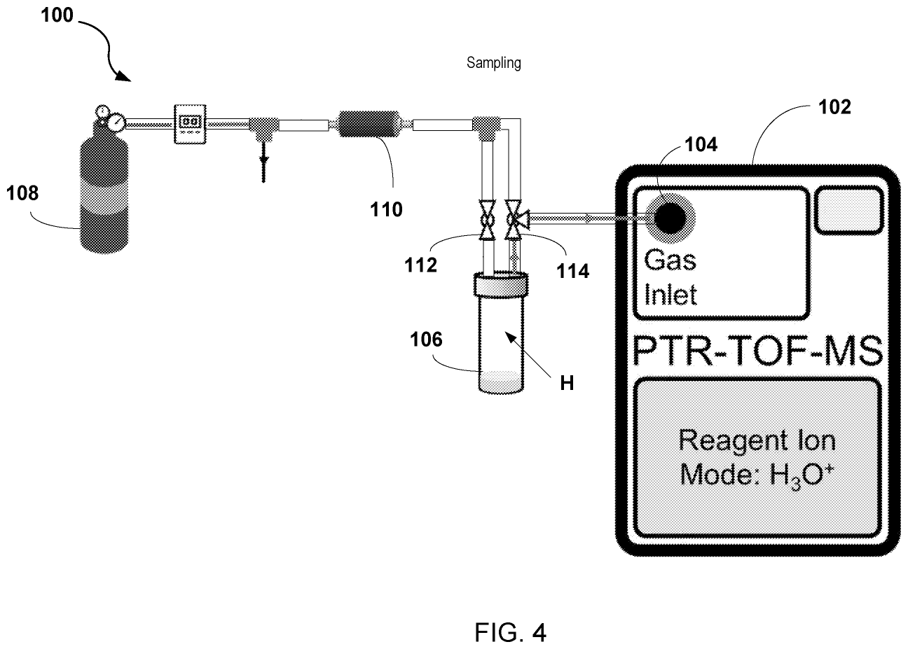

Maintaining zero air flow to the gas inlet 104 during the equilibrium mode may condition the PTR-TOF-MS device 102 and associated flow paths while the headspace is isolated. After a desired equilibrium period has elapsed, the system 100 may transition from the equilibrium mode to the sampling mode described with respect to FIG. 4.

FIG. 4 illustrates an example of the headspace sampling system 100 during a sampling mode. The sampling mode is initiated after completion of the equilibrium mode described with respect to FIG. 3, during which a static gas-liquid equilibrium is established in the headspace of the sample container 106.

During the sampling mode, the purge valve 112 remains controlled to restrict zero air from entering the headspace of the sample container 106. The sample valve 114 is controlled to permit air from the headspace of the sample container 106 to flow to the gas inlet 104 of the PTR-TOF-MS device 102. In this configuration, air comprising volatile compounds present in the headspace is conveyed from the headspace directly to the PTR-TOF-MS device 102 for analysis.

In some examples, suction generated at the gas inlet 104 of the PTR-TOF-MS device 102 draws air from the headspace of the sample container 106 during the sampling mode. The sampling mode may be performed for a defined sample duration to enable analysis of volatile compounds present in the headspace while maintaining the static gas-liquid equilibrium established prior to sampling.

In some embodiments, the headspace air is delivered directly to the PTR-TOF-MS device 102 without collection on a sorbent material or trap. After completion of the sampling mode, the system 100 may be transitioned to another operating mode, such as a subsequent purge mode for analysis of an additional sample.

Referring back to FIG. 1, the zero air supply may be provide zero air which is purified of hydrocarbons. However, the zero air may still have hydrocarbon impurities which require further filtering. In some examples, the system may further include a hydrocarbon trap fluidly connected between the zero air supply and the purge valve and sample valve. For example, the hydrocarbon trap may be down stream of the zero air supply and upstream of the purge valve. The hydrocarbon trap may also be upstream of the sample valve when the sample valve is a three-way valve which permits zero air to by pass the head space.

In some examples, the system may include a mass flow controller upstream of the purge valve and downstream of the zero air supply. In addition, the system may include an excess flow splitter downstream of the mass flow controller. The mass flow controller ensures that the zero air flow exceeds that of the PTR-TOF-MS inlet flow. The excess zero air flow is then exhausted to ambient via the excess flow splitter. Usually, this is a small amount of flow.

The components of the system described herein may be connected by tubing or piping. In the examples shown in the figures, the zero air supply, mass flow controller, excess flow splitter, and hydrocarbon trap may be connected in series. The zero air supply may be upstream of the mass flow controller. The mass flow controller may be upstream of the excess flow splitter. The excess flow splitter may be upstream of the hydrocarbon trap.

In some examples, the system may further include a valve splitter which has receives zero air and connects to the purge valve and sample valve. For example, the valve splitter may be down stream of the hydrocarbon trap and upstream of the sample valve and purge valve.

It should be appreciated that the system may be implemented in various ways with more or less components than described. In some example, the system may include a processor. The processor may cause actuation of the purge valve or solenoid valve as described herein. Alternatively, the purge valve and/or hand valve may be manually operated.

### Experimental Results and Examples

The headspace sampling system was further evaluated using surface water samples collected from an environmental contamination site. The samples were analyzed using a PTR-TOF-MS device configured to detect volatile organic compounds present in the headspace above the liquid samples.

Prior to sampling, the headspace of each sample container was purged with zero air to reduce interference from laboratory air. Following purging, the headspace was isolated for a period sufficient to allow volatile compounds in the liquid sample to equilibrate with the headspace. During this equilibrium period, zero air was supplied to the PTR-TOF-MS device via a bypass path to condition the instrument while maintaining isolation of the headspace.

After equilibration, headspace air was delivered directly to the PTR-TOF-MS device without the use of a sorbent trap or intermediate collection step. The PTR-TOF-MS device enabled detection of numerous volatile organic compounds in the samples, demonstrating that the disclosed system is suitable for rapid screening of complex mixtures of volatile chemicals in environmental liquid samples.

These results illustrate that the disclosed system and methods enable effective and rapid headspace analysis using PTR-TOF-MS, including in applications related to environmental monitoring and emergency response, without reliance on purge-and-trap or gas chromatographic separation techniques.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A system, comprising:
a proton transfer reaction time-of-flight mass spectrometry (PTR-TOF-MS) device comprising a gas inlet;
an air supply comprising zero air under pressure;
a sample container having a liquid sample disposed therein and defining a headspace above the liquid sample;
a purge valve connected downstream of the air supply and connected upstream of the headspace of the sample container;
a sample valve connected downstream of the headspace of the sample container and upstream of the gas inlet of the PTR-TOF-MS device;
wherein the system is operable in a purge mode by:
causing the purge valve to permit zero air from the air supply to enter the headspace of the sample container, and
causing the sample valve to permit air from the headspace of the sample container to flow to the gas inlet of the PTR-TOF-MS device;
wherein the system is operable in an equilibrium mode by:
causing the purge valve to restrict zero air from entering the headspace of the sample container, and
causing the sample valve to restrict air from flowing from the headspace of the sample container to the gas inlet of the PTR-TOF-MS device,
such that the headspace is fluidly isolated to allow volatile compounds in the liquid sample to establish a static gas-liquid equilibrium; and
wherein the system is operable in a sampling mode by:
causing the sample valve to permit air from the headspace of the sample container to enter the gas inlet of the PTR-TOF-MS device for a sample duration.

2. The system of claim 1, wherein during the equilibrium mode the sample valve fluidly connects the air supply to the gas inlet of the PTR-TOF-MS device such that zero air is supplied to the PTR-TOF-MS device while the headspace of the sample container remains fluidly isolated.

3. The system of claim 2, wherein the sample valve is a three-way valve having (i) a headspace-to-inlet state, (ii) a bypass state in which zero air bypasses the headspace and flows directly to the gas inlet, and (iii) a closed state.

4. The system of claim 1, further comprising a hydrocarbon filter connected between the air supply and the purge valve.

5. The system of claim 1, wherein the purge valve is a two-way valve.

6. The system of claim 1, further comprising a mass flow controller disposed upstream of the purge valve and configured to provide a zero-air flow rate that exceeds an inlet flow rate of the PTR-TOF-MS device.

7. The system of claim 6, further comprising an excess-flow outlet configured to exhaust a portion of the zero-air flow to prevent over-pressurization of the sample container.

8. The system of claim 1, wherein a transfer line between the sample valve and the gas inlet of the PTR-TOF-MS device is heated to reduce condensation of volatile organic compounds.

9. The system of claim 1, wherein the system is free of a sorbent trap configured to collect volatile organic compounds prior to analysis, and wherein headspace air is delivered directly to the PTR-TOF-MS device.

10. The system of claim 1, wherein the PTR-TOF-MS device provides suction at the gas inlet to draw headspace air from the sample container during the sampling mode.

11. The system of claim 1, wherein the equilibrium mode is performed at ambient temperature without active heating of the sample container.

12. A method, comprising:
purging a headspace of a sample container using zero air by:
causing a purge valve to permit zero air from a pressurized air supply to enter a headspace of a sample container having a liquid sample disposed therein; and
causing a sample valve to permit air from the headspace of the sample container to flow to a gas inlet of a proton transfer reaction time-of-flight mass spectrometry (PTR-TOF-MS) device;
establishing a static gas-liquid equilibrium in the headspace by:
causing the purge valve to restrict zero air from entering the headspace of the sample container; and
causing the sample valve to restrict air from flowing from the headspace of the sample container to the gas inlet of the PTR-TOF-MS device,
such that the headspace is fluidly isolated while volatile compounds in the liquid sample equilibrate with the headspace; and
sampling the headspace after the static gas-liquid equilibrium is established by:
causing, for a sample duration, the sample valve to permit air from the headspace of the sample container to enter the gas inlet of the PTR-TOF-MS device.

13. The method of claim 12, wherein during the establishing step the sample valve fluidly connects the air supply to the gas inlet of the PTR-TOF-MS device such that zero air flows to the PTR-TOF-MS device while the headspace of the sample container remains fluidly isolated.

14. The method of claim 13, wherein the sample valve is a three-way valve having (i) a headspace-to-inlet state, (ii) a bypass state in which zero air bypasses the headspace and flows to the gas inlet, and (iii) a closed state.

15. The method of claim 13, wherein the headspace air is delivered directly to the PTR-TOF-MS device without collection on a sorbent trap.

16. The method of claim 12, wherein purging the headspace comprises controlling a zero-air flow rate using a mass flow controller such that the zero-air flow rate exceeds an inlet flow rate of the PTR-TOF-MS device.

17. The method of claim 16, further comprising exhausting a portion of the zero-air flow to prevent over-pressurization of the sample container.

18. The method of claim 12, wherein purging the headspace comprises passing the zero air through a hydrocarbon filter prior to introducing the zero air into the headspace.

19. The method of claim 12, wherein sampling the headspace comprises drawing air from the headspace using suction generated at the gas inlet of the PTR-TOF-MS device.

20. The method of claim 12, further comprising heating a transfer line between the sample valve and the gas inlet of the PTR-TOF-MS device to reduce condensation of volatile organic compounds.
